(19) United States
(12) Patent Application Publication
(10) Pub. No.: US 2002/0020434 A1
(43) Pub. Date: Feb. 21, 2002

(54) Injection molded disposable core featuring recessed pores for substrate treatment member

(76) Inventors: Daniel T. McMullen, El Dorado Hills, CA (US); Paul A. Getchel, Placerville, CA (US); Vincent J. Catalano, Folsom, CA (US); Douglas G. Gardner, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/893,150

(22) Filed: Jun. 26, 2001

Related U.S. Application Data
(60) Provisional application No. 60/216,780, filed on Jul. 7, 2000.

(51) Int. Cl. B08B 7/00

(52) U.S. Cl. 134/6; 134/201

(57) ABSTRACT

A disposable core structure supports a porous polymeric brush utilized in the treatment of substrates. The disposable core structure includes an exterior surface featuring a plurality of waffle-like recesses separated by walls having sufficient thinness to permit fabrication by injection molding. The core structure includes an end adapted to permit attachment to a rotating member of an associated substrate handling apparatus. The end of the core structure further includes an opening to a bore in fluid communication with pores on the exterior surface of the core structure. Injection molding allows economical mass production of the core structure, permitting it to be fitted with the polymeric brush in a clean room setting and then be permanently fixed to a single brush. This avoids problems of bunching, tearing, wrinkling and stretching associated with replacement of brushes in the field that requires the brush to be fitted around a conventional nondisposable core.

### CROSS-REFERENCE TO RELATED APPLICATIONS

The instant non-provisional patent application claims priority from U.S. provisional patent application No. 60/216,780, filed Jul. 7, 2000 and entitled “Injection Molded Disposable Core Featuring Recessed Pores for Substrate Treatment Member.” This provisional application is hereby incorporated by reference.

### BACKGROUND OF THE INVENTION

The present invention relates to the manufacture of objects. More particularly, the present invention provides a disposable, injection-molded core for supporting a substrate treatment “scrubbing” brush utilized to manufacture integrated circuits. Merely by way of example, the present invention is applied to a substrate treatment device for the manufacture of integrated circuits. It will be recognized that the invention has a wider range of applicability; it can also be applied to the manufacture of semiconductor substrates, flat panel displays, hard disks, and the like.

In the manufacture of electronic devices such as integrated circuits, the presence of particulate contamination, trace metals, and mobile ions on a wafer is a serious problem. Particulate contamination can cause a wide variety of problems such as electrical “opens” or “shorts” in the integrated circuit. These opens and shorts often lead to reliability and functional problems in the affected integrated circuit. Mobile ion and trace metal contaminants can also lead to reliability and functional problems in the integrated circuit. The combination of these factors is the main source of lower device yields on a wafer, thereby increasing the cost of an average functional device on the wafer.

Chemical-mechanical polishing (“CMP”) is a commonly used technique for planarizing a film on a wafer prior to subsequent processing. CMP often requires introduction of a polishing slurry onto a surface of a film on the semiconductor wafer as the wafer is being mechanically polished against a rotating polishing pad. The slurries typically are water based and can contain fine abrasive particles such as silica, alumina, and other abrasive materials. After polishing is complete, the processed wafers must be cleaned to completely remove residual slurry and other residue from the polishing process to prepare the surface for other processing steps such as etching, photolithography, and others.

To clean residual slurry material from the polished surface, cleaning brushes have been used. A cleaning brush of this type often comprises a member that is cylindrical in shape, which generally rotates along a center axis of the cylindrical shaped core structure. The cleaning brushes are also often made of a foam or porous polymeric material such as polyvinyl acetal (“PVA”). A combination of rotational movement of the brush and force or pressure placed on the brush against the wafer causes residual slurry materials to be removed from the surface of the wafer.

Although scrubbing brushes have been partly effective in removing particles and/or contamination from the disk, a variety of limitations still exist with their use in the manufacture of integrated circuits.

One such limitation is brush replacement. Specifically, the brushes eventually wear out due to frequent rotational contact with the substrate. However, the brushes are designed to be tightly fitted around the underlying rotatable core structure in order to prevent slippage and ensure uniform contact with the substrate. Inserting a new brush over the existing core structure can thus cause problems of tearing, wrinkling, stretching, or bunching of the brush as it is installed, and may also give rise to brush contamination.

From the above, it is seen that an improved structure and method for replacing scrubbing brushes utilized in the treatment of substrates is highly desired.

### SUMMARY OF THE INVENTION

According to the present invention, a technique including a treatment device for cleaning surfaces is provided. In an exemplary embodiment, the present invention provides for fabrication and use of an injection-molded disposable core structure for supporting a substrate treatment brush.

In one specific embodiment, the present invention provides an elongated injection-molded core member comprising a first end and a second end. The first end is configured to receive projections from a rotating member of an associated substrate treatment apparatus, and also includes an opening to a bore disposed along substantially the length of the member. An exterior surface of the elongated core member features a plurality of waffle-like recesses separated by sufficiently thin walls to permit fabrication by injection molding. The exterior surface of the elongated core member also features channels disposed substantially along the core length and in fluid communication with the bore.

During operation of the substrate treatment device, cleaning or rinsing fluid flows into the opening of the first end, through the bore, and is flushed out of the pores into porous polymeric material surrounding the core. Injection molding of the core structure permits it to be economically fabricated and tightly fitted within the porous polymeric member during manufacture for single-use only applications.

These and other embodiments of the present invention, as well as its advantages and features are described in more detail in conjunction with the text below and attached Figures.

### BRIEF DESCRIPTION OF THE DRAWINGS

FIG. 1A is a simplified first perspective view of one embodiment of a disposable core structure in accordance with the present invention inserted within a cylindrical porous polymeric brush.

FIG. 1B is a simplified second perspective view of the core structure of FIG. 1A.

FIG. 1C is a simplified first side view of the core structure of FIG. 1A.

FIG. 1D is a simplified cross-sectional view of the core structure of FIG. 1C along line 1D-1D.

FIG. 1E is a simplified second side view of the core structure of FIG. 1A.

FIG. 1F is a simplified cross-sectional view of the core structure of FIG. 1E taken along the line 1F-1F′.

FIG. 1G is a simplified view of the first end of the core structure of FIG. 1A.

FIG. 1H is a simplified cross-sectional view of the core structure of FIG. 1E taken along the line 1G-1G′.

FIG. 1I is a simplified cross-sectional view of the core structure of FIG. 1E taken along the line 1I-1I′.

FIG. 2A is a simplified first perspective view of a first alternative embodiment of a disposable core structure in accordance with the present invention inserted within a cylindrical porous polymeric brush.

FIG. 2B is a simplified second perspective view of the core structure of FIG. 2A.

FIG. 2C is a simplified first side view of the core structure of FIG. 2A.

FIG. 2D is a simplified cross-sectional view of the core structure of FIG. 2C along the line 2D-2D′.

FIG. 2E is a simplified second side view of the core structure of FIG. 2A.

FIG. 2F is a simplified cross-sectional view of the core structure of FIG. 2E along the line 2F-2F′.

FIG. 2G is a simplified view of the first end of the core structure of FIG. 2A.

FIG. 2H is a simplified view of the second end of the core structure of FIG. 2A.

FIG. 2I is a simplified cross-sectional view of the core structure of FIG. 2E taken along the line 2I-2I′.

FIG. 3A is a simplified cross-sectional view of the core structure of FIGS. lA-1I as positioned within a six-part mold.

FIG. 3B is a simplified cross-sectional view of the core structure of FIGS. 1A-1I after withdrawal of the six-part mold to produce the molded core.

FIG. 4A is a simplified cross-sectional view of the core structure of FIGS. 2A-2I as positioned within a four-part mold.

FIG. 4B is a simplified cross-sectional of the core structure of FIGS. 2A-2I after withdrawal of the four-part mold to produce the molded core.

FIG. 5A is a simplified first perspective view of a second alternative embodiment of a disposable core structure in accordance with the present invention inserted within a cylindrical porous polymeric brush.

FIG. 5B is a simplified second perspective view of the core structure of FIG. 5A.

FIG. 5C is a simplified first side view of the core structure of FIG. 5A.

FIG. 5D is a simplified cross-sectional view of the core structure of FIG. 5C along line 5D-5D′.

FIG. 5E is a simplified second side view of the core structure of FIG. 5A.

FIG. 5F is a simplified cross-sectional view of the core structure of FIG. 5E taken along the line 5F-5F′.

FIG. 5G is a simplified view of the first end of the core structure of FIG. 5A.

### DESCRIPTION OF THE SPECIFIC EMBODIMENTS

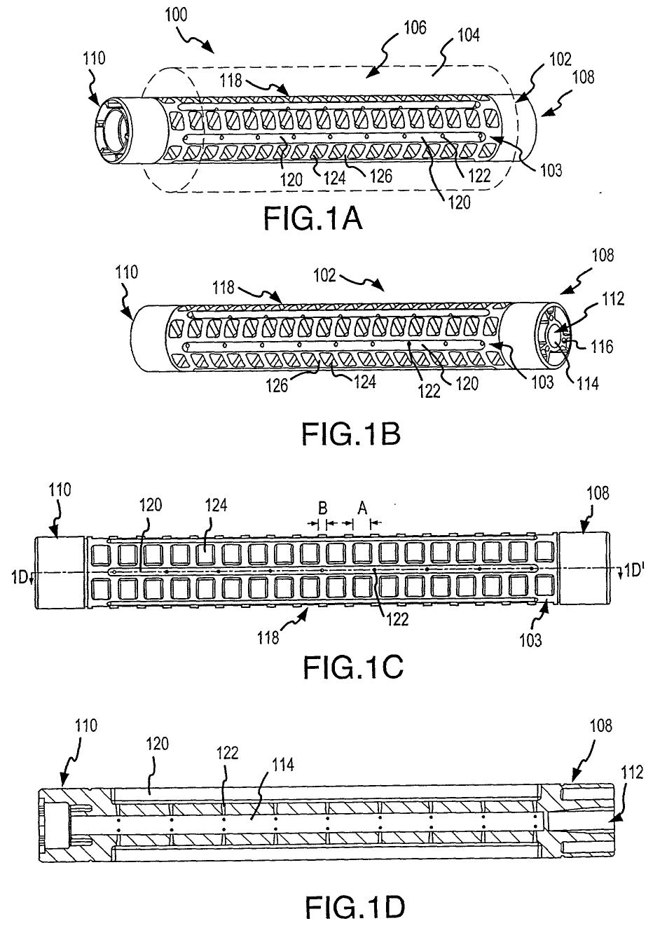

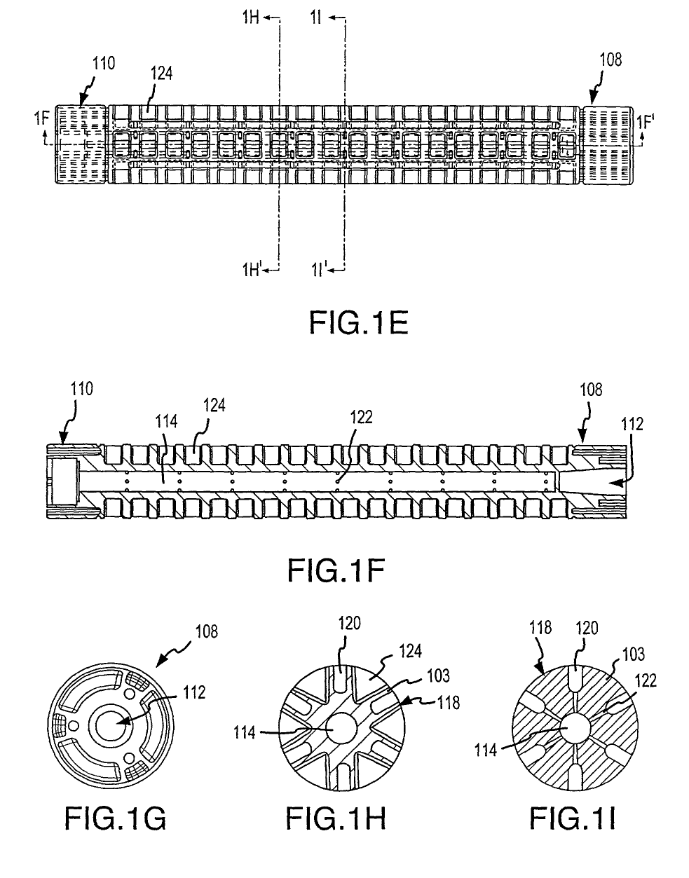

FIGS. 1A-1I show various simplified views of a surface treatment device according to one embodiment of the present invention. FIG. 1A is a first perspective view of one embodiment of a disposable core structure in accordance with the present invention inserted within a cylindrical porous polymeric brush. FIG. 1B is a second perspective view of the core structure of FIG. 1A. FIG. 1C is a first side view of the core structure of FIG. 1A. FIG. 1D is a cross-sectional view of the core structure of FIG. 1C along line 1D-1D. FIG. 1E is a second side view of the core structure of FIG. 1A. FIG. 1F is a cross-sectional view of the core structure of FIG. 1E taken along the line 1F-1F′. FIG. 1G is a view of the first end of the core structure of FIG. 1A. FIG. 1H is a cross-sectional view of the core structure of FIG. 1E taken along the line 1G-1G′. FIG. 1I is a cross-sectional view of the core structure of FIG. 1E taken along the line 1I-1I′. FIGS. 1A-1I are merely illustrative and should not limit the scope of the claims herein. One of ordinary skill in the art would recognize other variations, modifications, and alternatives.

As shown, surface treatment device 100 comprises an elongated core structure 102 disposed within a channel or bore of a cylindrical porous polymeric brush 104 having a rotatable surface 106.

Core structure 102 includes a body 103, first end 108, and a second end 110. First end 108 features opening 112 into bore 114 running substantially the length of body 103. First end 108 also features holes 116. Holes 116 serve as a contact point for receiving pins which allow core structure 102 to be secured to a rotating member of an associated substrate treatment device.

Body 103 of core structure 102 features exterior surface 118 bearing a plurality of channels 120. Channels 120 include pores 122 in fluid communication with bore 114. Exterior surface 118 of core structure 102 also includes a plurality of waffle-shaped recesses 124 having width A separated by thin walls 126 having thickness B. In the embodiment of the present invention shown in FIGS. 1A-1I, waffle-shaped recesses 124 do not extend into contact with bore 114.

The design of the core structure with waffle-shaped indentations permits the core to be fabricated utilizing injection molding techniques. Injection molding imposes a limit on the maximum thickness of walls to be formed. The walls separating the waffle-shaped recesses are thin, but they convey sufficient structural strength to the core to allow it to support the surrounding porous polymeric brush during rotation and contact with the substrate.

The use of injection molding permits the core structure to be economically manufactured and then fitted within the surrounding porous polymeric brush in a factory setting. Upon brush replacement, the core is simply thrown away with the brush, thereby avoiding the effort and potential damage or contamination associated with fitting a new porous polymeric brush around a conventional reusable core structure.

As can be appreciated by one of skill in the art, the precise dimensions of the injection molded core structure will vary depending upon the composition of the molded material and the shape of the core. In the embodiment of the present invention illustrated in FIGS. 1A-1I above, the core is composed of polypropylene. In general, the maximum thickness of walls of injection-molded polypropylene is between 3 and 5 mm. Thus thickness A of the walls separating the waffle-shaped recesses is approximately 0.15″ (3.8 mm), and width A of the waffle-shaped recesses is approximately 0.35″ (8.87 mm). Bore 114 has a diameter of 0.385″ (9.75 mm) and external surface 118 has a diameter of 1.385″ (35 mm). The precise relationship between the radius of the bore and the exterior surface will depend upon the material to be injection-molded and the conditions of such molding.

In a preferred embodiment, the surface treatment device provides a structure that is suitable for easier installation (or removal) from a substrate treatment apparatus having a rotating portion. Specifically, the first end of the core structure includes holes designed to receive appendages of a rotating portion of an associated wafer treatment apparatus.

In some embodiments, the device or porous polymeric product (e.g., foam products) can range in size and shape, depending upon the application. According to an embodiment, the device can be shaped as brush rollers, which can have protrusions thereon, or as brush rollers that have smooth surfaces. These brush rollers have shapes and sizes to meet the particular cleaning application for devices such as semiconductor wafers, hard disks, and other applications. A detailed description of other types of products are illustrated in U.S. Ser. No. 09/193,054 (Attorney Docket No. 18886-001310, commonly assigned, which is incorporated by reference herein.

While the above is a full description of the specific embodiments, various modifications, alternative constructions and equivalents may be used. For example, the core structure is not limited to injection molding of polypropylene, but could be composed of other injection-molded materials, including but not limited to acetal, polyvinylidene fluoride (PVDF), or polyvinyl chloride (PVC).

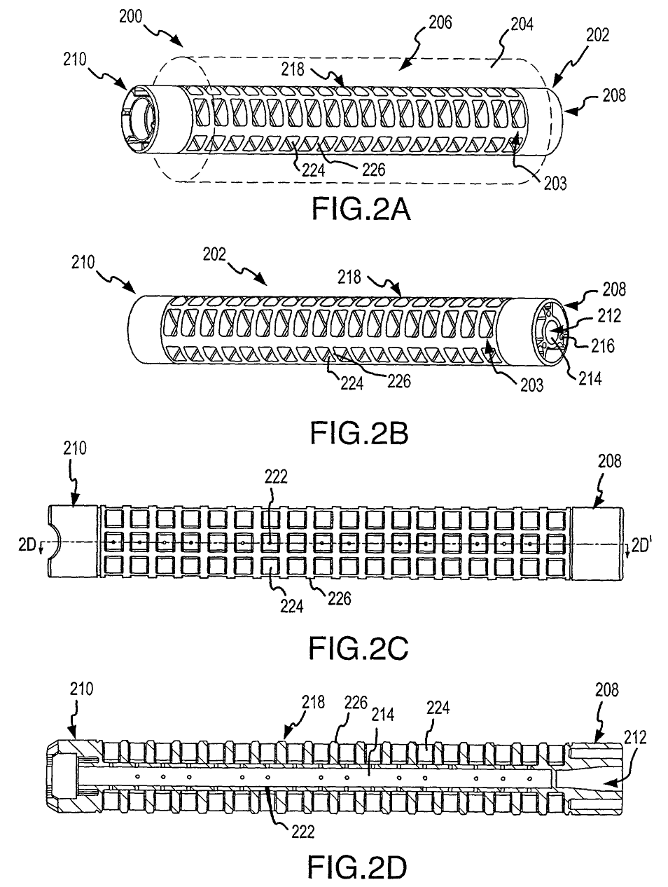

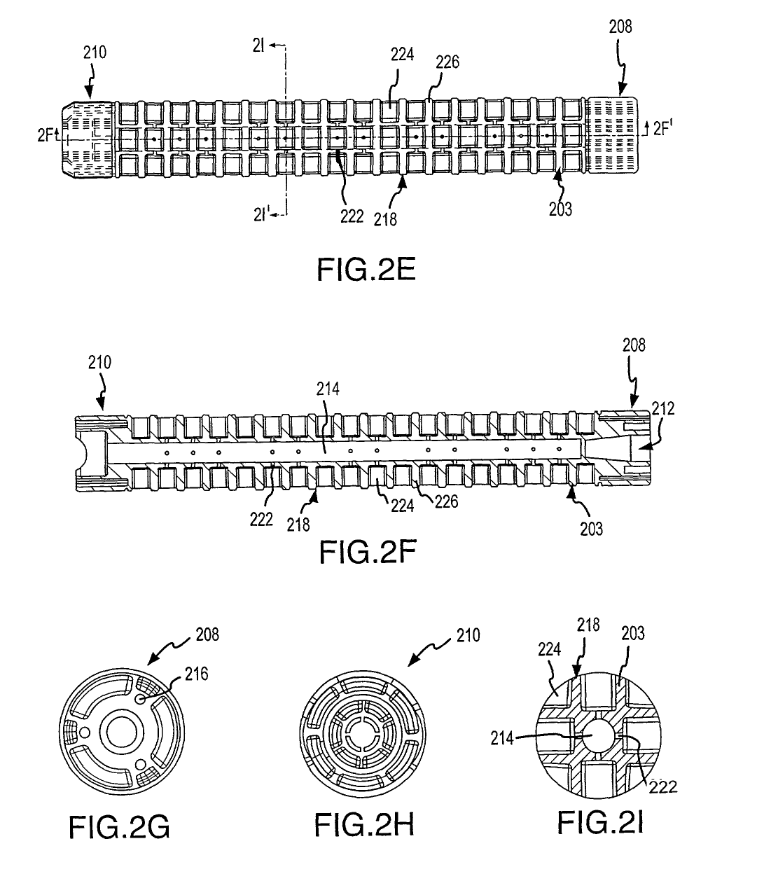

In addition, other core shapes and configurations are possible. For example, FIGS. 2A-2I show various simplified views of a surface treatment device according to an alternative embodiment of the present invention. FIG. 2A is a first perspective view of a second embodiment of a disposable core structure in accordance with the present invention inserted within a cylindrical porous polymeric brush. FIG. 2B is a second perspective view of the core structure of FIG. 2A. FIG. 2C is a first side view of the core structure of FIG. 2A. FIG. 2D is a cross-sectional view of the core structure of FIG. 2C along the line 2D-2D′. FIG. 2E is a second side view of the core structure of FIG. 2A. FIG. 2F is a cross-sectional view of the core structure of FIG. 2E along the line 2F-2F′. FIG. 2G is a view of the first end of the core structure of FIG. 2A. FIG. 2H is a view of the second end of the core structure of FIG. 2A. FIG. 2I is a cross-sectional view of the core structure of FIG. 2E taken along the line 2I-2I′. FIGS. 2A-2I are merely illustrative and should not limit the scope of the claims herein. One of ordinary skill in the art would recognize other variations, modifications, and alternatives.

First alternative embodiment 200 of the surface treatment device comprises an elongated core structure 202 disposed within a channel of a cylindrical porous polymeric brush 204 having surface 206. Core structure 202 includes body 203, first end 208, and a second end 210. First end 208 features opening 212 into bore 214 running substantially the length of body 203. First end 208 also features holes 216. Holes 216 serve as a contact point for receiving pins which allow core structure 202 to be secured to a rotating member of an associated substrate treatment device.

Body 203 of core structure 202 features exterior surface 218 bearing a plurality of waffle-shaped recesses 224 separated by thin walls 226. As described above, the configuration of the recesses separated by the thin walls enables the core to be fabricated by injection molding while retaining sufficient strength to support the porous polymeric brush in contact with the substrate.

In the embodiment shown in FIGS. 2A-2I, pores 222 are positioned at the bottom of recesses 224 and in fluid communication with bore 214. This location of pores 222 confers the advantage of simplifying the design of the core structure.

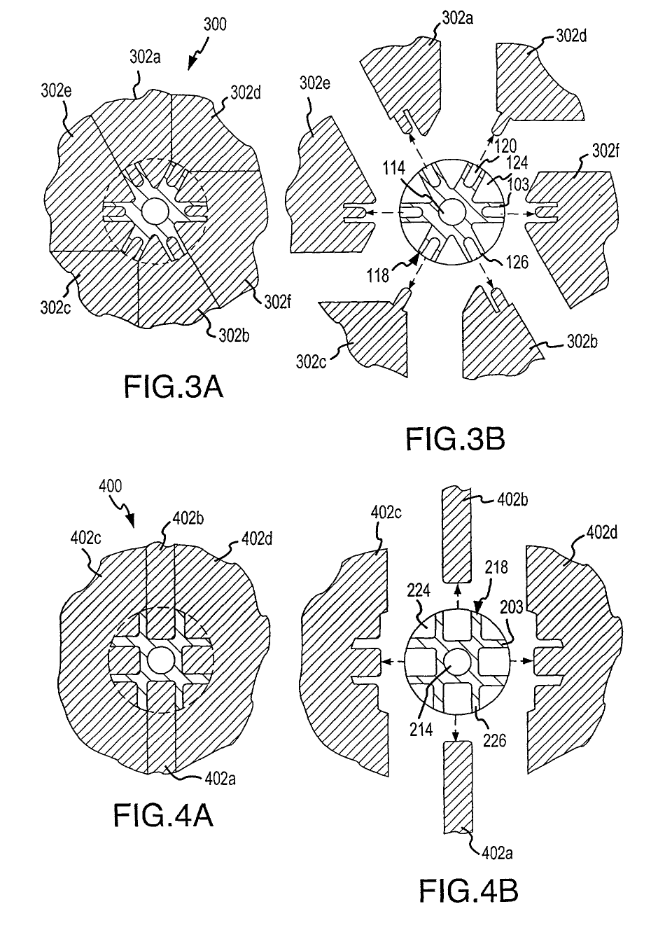

Specifically, whereas the embodiment of the disposable core structure described in conjunction with FIGS. 1A-1I can be fabricated from a mold having a minimum of six parts, the disposable core structure described in conjunction with FIGS. 2A-2I can be fabricated from a mold having only four parts. This is illustrated in conjunction with FIGS. 3A-3B and 4A-4B.

FIG. 3A is a simplified cross-sectional view of the core structure of FIGS. 1A-1I as positioned within a six-part mold. FIG. 3B is a simplified cross-sectional view of the core structure of the withdrawal of the six-part mold to produce the molded core. FIGS. 3A-3B show that due to the configuration of separate channels and recesses on the exterior surface of the core, mold 300 having at least six pieces 302a-f is required for fabrication of the core.

FIG. 4A is a simplified cross-sectional view of the core structure of FIGS. 2A-2I as positioned within a four-part mold. FIG. 4B is a simplified cross-sectional view of the withdrawal of the four-part mold to produce the molded core. FIGS. 4A-4B show that due to the simplified surface of just recesses on the exterior surface of the core, mold 400 having only four pieces 400a-d is required for fabrication of the core. This simpler mold structure affords the alternative core design advantages in the economical production of the core structure.

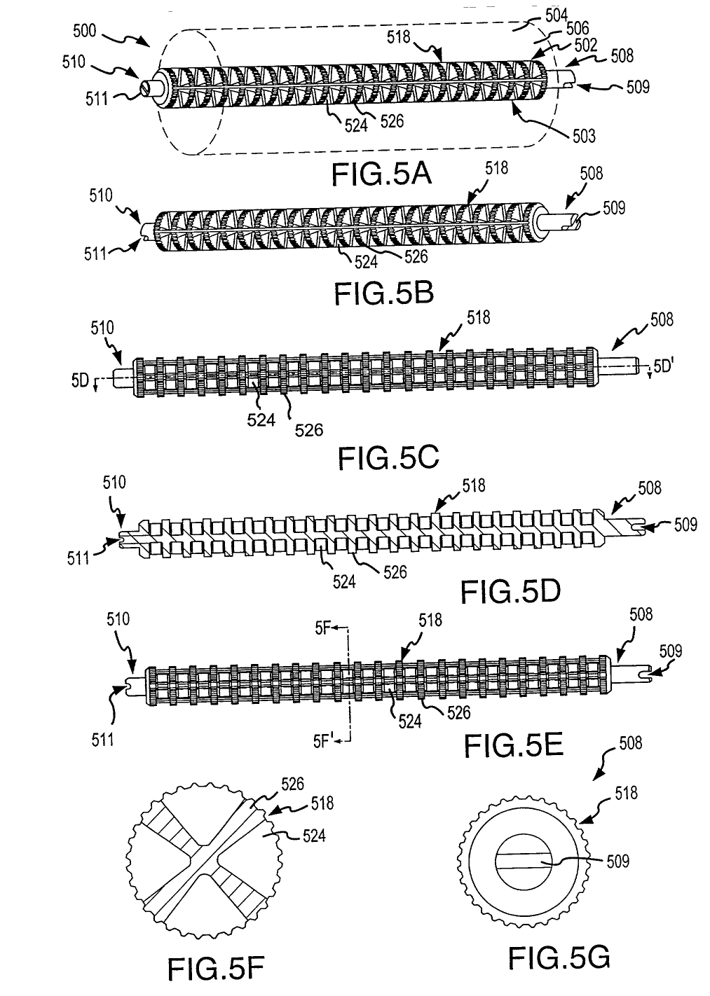

While the specific embodiments described above in connection with FIGS. 1A-1I and 2A-2I feature an injection-molded disposable core structure having a bore running therethrough to allow the flow of a liquid material, this is not required by the present invention. FIGS. 5A-5G illustrate various simplified views of a core structure in accordance with a second alternative embodiment of the present invention, which does not feature a central bore.

FIG. 5A is a first perspective view of a second alternative embodiment of a disposable core structure in accordance with the present invention inserted within a cylindrical porous polymeric brush. FIG. 5B is a second perspective view of the core structure of FIG. 5A. FIG. 5C is a first side view of the core structure of FIG. 5A. FIG. 5D is a cross-sectional view of the core structure of FIG. 5C along line 5D-5D′. FIG. 5E is a second side view of the core structure of FIG. 5A. FIG. 5F is a cross-sectional view of the core structure of FIG. 5E taken along the line 5F-5F′. FIG. 5G is a view of the first end of the core structure of FIG. 5A.

Second alternative embodiment 500 of the surface treatment device comprises an elongated core structure 502 disposed within a channel of a cylindrical porous polymeric brush 504 having surface 506. Core structure 502 includes body 503, first end 508, and a second end 510. First end 508 and second end 510 feature slots 509 and 511 respectively that allow core structure 502 to be secured to a rotating member of an associated substrate treatment device.

Body 503 of core structure 502 features exterior surface 518 bearing a plurality of waffle-shaped recesses 524 separated by thin walls 526. As described above, the configuration of the recesses separated by the thin walls enables the core to be fabricated by injection molding while retaining sufficient physical strength to support the porous polymeric brush in contact with the substrate.

In addition to the surface treatment device featuring the disposable core structure described above, embodiments of the present invention also relate to methods of utilizing a surface treatment device. Specifically, a method for utilizing a surface treatment device comprises providing in a clean room environment a brush product substantially unused in any prior surface treatment operation, and providing in the clean room environment an injection molded disposable core having a waffle type structure. The brush product is fitted to the disposable core in the clean room environment to form the surface treatment device, preventing contamination from accumulating onto the surface treatment device during the fitting process. The surface treatment device is packaged in the clean room environment, and the packaged surface treatment device is provided for use with the substrate treatment apparatus. Once the brush product becomes worn, the entire surface treatment device is removed from the surface treatment apparatus, discarded, and replaced with a new surface treatment device.

Given the variety of embodiments of the present invention just described, the above description and illustrations should not be taken as limiting the scope of the present invention which is defined by the appended claims.

What is claimed is:

1. A disposable core structure comprising:
an injection-molded body having an exterior surface including a first waffle-like recess separated from a second waffle-like recess by a thin wall; and
a connection point for receiving a rotating member of an associated substrate treatment apparatus.

2. The core structure of claim 1 wherein the body further comprises a first end and a second end, the first end including an opening to a bore that is disposed substantially along a length of the body.

3. The core structure of claim 2 wherein the external surface comprises a pore in fluid communication with the bore.

4. The core structure of claim 3 wherein the pore is positioned in a channel on the exterior surface of the body.

5. The core structure of claim 3 wherein the pore is positioned at a bottom of at least one of the first recess and the second recess.

6. The core structure of claim 1 wherein the body is composed of injection molded polypropylene.

7. The core structure of claim 1 wherein the body is composed of injection molded acetal.

8. The core structure of claim 1 wherein the body is cylindrical in shape.

9. A substrate treatment device comprising a porous polymeric brush member in contact with an injection-molded core structure, the core structure having an exterior surface having a first waffle-like recess separated from a second waffle-like recess by a thin wall, and a connection point for receiving a rotating member of an associated substrate treatment apparatus.

10. The substrate treatment device of claim 9 wherein the core structure further comprises a first end and a second end, the first end including an opening to a bore that is disposed substantially along a length of the core.

11. The substrate treatment device of claim 9 wherein the porous polymeric brush is a cylinder and the core structure is inserted within an internal channel of the porous polymeric brush.

12. A method for utilizing a surface treatment device comprising:
providing in a clean room environment a brush product substantially unused in any prior surface treatment operation;
providing in the clean room environment an injection molded disposable core having a waffle type structure;
fitting the brush product to the disposable core in the clean room environment to form the surface treatment device, preventing contamination from accumulating onto the surface treatment device during the fitting process;
packaging the surface treatment device in the clean room environment; and
providing the packaged surface treatment device for use with the substrate treatment apparatus.

13. The method of claim 12 wherein fitting the brush product to the disposable core comprises inserting the disposable core within a channel in the brush product.

14. The method of claim 12 wherein providing the packaged surface treatment device comprises fixing the disposable core to a rotatable portion of a substrate treatment apparatus.

15. The method of claim 12 wherein fixing the disposable core to the rotatable portion comprises inserting appendages of the rotatable portion into holes of a first end of the disposable core.

16. The method of claim 12 further comprising:
operating the scrubbing apparatus until the brush product becomes worn;
removing the surface treatment device from the substrate treatment apparatus,
discarding the surface treatment device; and
providing a replacement surface treatment device to the substrate treatment apparatus.
